(19) United States
(12) Patent Application Publication
(10) Pub. No.: US 2026/0219388 A1
(43) Pub. Date: Jul. 30, 2026

(54) SETTING DEVICE FOR RADIO WAVE SENSOR, RADIO WAVE SENSOR, METHOD FOR SETTING RADIO WAVE SENSOR, AND NON-TRANSITORY COMPUTER-READABLE STORAGE MEDIUM STORING A COMPUTER PROGRAM

(71) Applicant: SUMITOMO ELECTRIC INDUSTRIES, LTD., Osaka-shi, Osaka (JP)

(72) Inventor: Atsushi HIGASHI, Osaka-shi (JP)

(73) Assignee: SUMITOMO ELECTRIC INDUSTRIES, LTD., Osaka-shi, Osaka (JP)

(21) Appl. No.: 19/144,699

(22) PCT Filed: Nov. 24, 2023
(86) PCT No.: PCT/JP2023/042105

§ 371 Date: Jun. 30, 2025

(30) Foreign Application Priority Data
Jan. 6, 2023 (JP) 2023-000968

(51) Int. Cl. G01S 13/91; G01S 13/58

(52) U.S. Cl. CPC G01S 13/91; G01S 13/584

(57) ABSTRACT

This setting device for a radio wave sensor comprises: an acquisition unit that acquires a result of sensing of an object moving on a crosswalk by the radio wave sensor; a generation unit that generates, on the basis of the sensing result, a moving trajectory of the object in a coordinate space which is preset for the radio wave sensor; and a determination unit that determines a sensing area corresponding to the crosswalk in the coordinate space on the basis of the moving trajectory of the object. The sensing area includes a first area including the crosswalk. The determination unit determines a borderline between the first area and a second area which is provided for a pedestrian to wait before crossing the crosswalk, on the basis of the moving trajectory of a vehicle traveling on a first roadway partially overlapping the crosswalk.

### TECHNICAL FIELD

The present disclosure relates to a setting device for a radio wave sensor, a radio wave sensor, a method for setting radio wave sensor, and a non-transitory computer-readable storage medium storing a computer program. This application claims priority based on Japanese Patent Application No. 2023-000968 filed on Jan. 6, 2023 and the entire contents of the Japanese patent application are incorporated herein by reference.

### BACKGROUND ART

A radio wave sensor is installed at a position where it can detect vehicles, pedestrians, and other objects on the road or at intersections for the purpose of traffic monitoring. Such a radio wave sensor of an infrastructure (road facility) is used for, for example, traffic volume measurement of vehicles traveling on a road and pedestrian detection on a crosswalk. In order to use the radio wave sensor for traffic monitoring, it is necessary to set an area to be detected (hereinafter, referred to as a “detection area”) such as a roadway, a lane, a crosswalk, or a sidewalk in a coordinate system of the radio wave sensor.

Patent literature 1 discloses that the detection area is defined by dividing it into four sub-areas: a sub-area in the crosswalk overlapping the outgoing lane where a vehicle exits the intersection, a sub-area in the crosswalk overlapping the incoming lane where a vehicle enters the intersection, a sub-area that is a waiting area for pedestrians adjacent to the outgoing lane, and a sub-area that is a waiting area for pedestrians adjacent to the incoming lane.

### CITATION LIST

### Patent Literature

Patent literature 1: Japanese Unexamined Patent Application Publication No. 2017-090078

### SUMMARY OF INVENTION

A setting device for a radio wave sensor according to an aspect of the present disclosure includes, an acquisition unit configured to acquire a detection result obtained by the radio wave sensor detecting an object moving on a crosswalk, a generation unit configured to generate a movement trajectory of the object in a coordinate space set in advance in the radio wave sensor, based on the detection result, and a determination unit configured to determine a detection area corresponding to the crosswalk in the coordinate space, based on the movement trajectory of the object. The detection area includes a first area including the crosswalk, and the determination unit is configured to determine a boundary line between the first area and a second area in which a passerby waits to cross the crosswalk, based on a movement trajectory of a vehicle traveling on a first roadway, the first roadway having a portion overlapping the crosswalk.

A radio wave sensor according to an aspect of the present disclosure includes a transmitting and receiving unit configured to transmit a radio wave to an area including a crosswalk and receive a reflected wave of the radio wave from an object, a detection unit configured to detect a position of the object moving on the crosswalk, based on the reflected wave received by the transmitting and receiving unit, a generation unit configured to generate a movement trajectory of the object in a coordinate space set in advance in the radio wave sensor, based on the position of the object, and a determination unit configured to determine a detection area corresponding to the crosswalk in the coordinate space, based on the movement trajectory of the object. The detection area includes a first area including the crosswalk, and the determination unit is configured to determine a boundary line between the first area and a second area in which a passerby waits to cross the crosswalk, based on a movement trajectory of a vehicle traveling on a first roadway, the first roadway having a portion overlapping the crosswalk.

A method for setting radio wave sensor according to an aspect of the present disclosure includes acquiring a detection result obtained by the radio wave sensor detecting an object moving on a crosswalk, generating a movement trajectory of the object in a coordinate space set in advance in the radio wave sensor, based on the detection result, and determining a detection area corresponding to the crosswalk in the coordinate space, based on the movement trajectory of the object. The detection area includes a first area including the crosswalk, and the determining includes determining a boundary line between the first area and a second area in which a passerby waits to cross the crosswalk, based on a movement trajectory of a vehicle traveling on a first roadway, the first roadway having a portion overlapping the crosswalk.

A computer program according to an aspect of the present disclosure is a computer program for setting a radio wave sensor for detecting an object on a crosswalk, the computer program causing a computer to execute acquiring a detection result obtained by the radio wave sensor detecting the object moving on the crosswalk, generating a movement trajectory of the object in a coordinate space set in advance in the radio wave sensor, based on the detection result, and determining a detection area corresponding to the crosswalk in the coordinate space, based on the movement trajectory of the object. The detection area includes a first area including the crosswalk, and the determining includes determining a boundary line between the first area and a second area in which a passerby waits to cross the crosswalk, based on a movement trajectory of a vehicle traveling on a first roadway, the first roadway having a portion overlapping the crosswalk.

### BRIEF DESCRIPTION OF THE DRAWINGS

FIG. 1 is a diagram showing an example of use of an infrastructure radio wave sensor according to an embodiment.

FIG. 2 is a diagram showing an example of a detection area.

FIG. 3 is a block diagram showing an example of a hardware configuration of the infrastructure radio wave sensor according to the embodiment.

FIG. 4 is a block diagram showing an example of a hardware configuration of the setting device according to the embodiment.

FIG. 5 is a functional block diagram showing an example of functions of the infrastructure radio wave sensor and the setting device according to the embodiment.

FIG. 6 is a diagram showing an example of the movement trajectory of an object.

FIG. 7 is a diagram for explaining an example of determination of a definition line along the longitudinal direction of a crosswalk.

FIG. 8 is a diagram for explaining an example of the tentative determination of a definition line along the width direction of a crosswalk.

FIG. 9 is a diagram for explaining an example of determination of the shapes of the first boundary line and the second boundary line.

FIG. 10 is a diagram for explaining an example of determining the positions of the first boundary line and the second boundary line.

FIG. 11 is a diagram for explaining an example of determination of a median strip area.

FIG. 12 is a diagram showing an example of a display screen by the display device.

FIG. 13 is a flowchart showing an example of the operation of the infrastructure radio wave sensor according to the embodiment.

FIG. 14 is a flowchart showing an example of the operation of the setting device according to the embodiment.

FIG. 15 is a functional block diagram showing one modification of the functionality of the infrastructure radio wave sensor according to an embodiment.

### DETAILED DESCRIPTION

### Problems to be Solved by Present Disclosure

In the intersection, a rounded corner may be provided at a connection point of two roadways. Thus, the boundary line between the crosswalk area overlapping the roadway and the waiting area overlapping the sidewalk is not necessarily to be a straight line. In the detection area of the radio wave sensor, a pedestrian crossing the crosswalk and a pedestrian waiting in the waiting area cannot be accurately distinguished unless the boundary line between the crosswalk area and the waiting area is accurately determined.

### Effects of Present Disclosure

According to the present disclosure, a boundary line between a crosswalk area and a waiting area in a detection area of a radio wave sensor can be correctly determined.

### Summary of Embodiments of Present Disclosure

The following is a summary of embodiments of the present disclosure.
(1) A setting device for a radio wave sensor according to the embodiment includes, an acquisition unit configured to acquire a detection result obtained by the radio wave sensor detecting an object moving on a crosswalk, a generation unit configured to generate a movement trajectory of the object in a coordinate space set in advance in the radio wave sensor, based on the detection result, and a determination unit configured to determine a detection area corresponding to the crosswalk in the coordinate space, based on the movement trajectory of the object. The detection area includes a first area including the crosswalk, and the determination unit is configured to determine a boundary line between the first area and a second area in which a passerby waits to cross the crosswalk, based on a movement trajectory of a vehicle traveling on a first roadway, the first roadway having a portion overlapping the crosswalk. The movement trajectory of the vehicle traveling along the roadway has a shape along the boundary line between the first area included in the roadway and the second area included in the sidewalk. Thus, the boundary line between the first area and the second area can be correctly determined.
(2) In the above (1), the detection area may further include the second area. According to this configuration, the boundary line between the first area and the second area can be determined more correctly.
(3) In the above (1) or (2), the determination unit may be configured to determine the boundary line, based on a movement trajectory of a vehicle turning right or left at an intersection between the first roadway and a second roadway intersecting the first roadway. The movement trajectory of the vehicle that turns right or left has a shape along the outer edge of the roadway at the intersection. Thus, for example, in the intersection provided with the rounded corner, the boundary line between the first area and the second area can be correctly determined.
(4) In the above (3), the determination unit may be configured to determine a shape of the boundary line, based on the movement trajectory of the vehicle turning right or left at the intersection. Thus, the shape of the boundary line between the first area and the second area can be correctly determined based on the movement trajectory of the shape along the outer edge of the roadway at the intersection.
(5) In the above (3) or (4), the detection area may include, as the second area, a first waiting area and a second waiting area, the first waiting area being in contact with an incoming lane where a vehicle is to enter the intersection on the first roadway, the second waiting area being in contact with an outgoing lane where a vehicle exits the intersection on the first roadway, and the determination unit may be configured to determine a first boundary line based on a first movement trajectory, the first boundary line being a boundary line between the first area and the first waiting area, the first movement trajectory being a movement trajectory of a vehicle turning left or right on the incoming lane and entering the second roadway, and may determine a second boundary line based on a second movement trajectory, the second boundary line being a boundary line between the first area and the second waiting area, the second movement trajectory being a movement trajectory of a vehicle turning left or right on the second roadway and entering the outgoing lane. The movement trajectory of the vehicle that turns right or left the incoming lane and enters the second roadway has a shape along the outer edge of the connection point between the second roadway and the incoming lane. Thus, the boundary line between the first area and the first waiting area can be correctly determined. The movement trajectory of the vehicle that turns right or left the second roadway and enters the outgoing lane has a shape along the outer edge of the connection point between the second roadway and the outgoing lane. Thus, the boundary line between the first area and the second waiting area can be correctly determined.
(6) In any one of (1) to (5), the determination unit may be configured to determine the boundary line, based further on a detection position of a passerby waiting to cross the crosswalk, the detection position being detected by the radio wave sensor. For example, during the period when the pedestrian traffic light displays red, pedestrians need to wait to cross the crosswalk. Thus, the passerby waiting to cross the crosswalk by the traffic light stays in the second area (waiting area). Thus, the boundary line between the first area and the second area can be determined more accurately by using the detection position of the passerby waiting to cross the crosswalk.
(7) In the above (6), the setting device may further include an identification unit configured to identify an object whose movement direction is indefinite, based on a plurality of the detection results acquired from the radio wave sensor by the acquisition unit. The determination unit may be configured to determine the boundary line, based on a position of the object identified by the identification unit. The pedestrian waiting to cross the crosswalk stops at a certain position or frequently changes the movement direction. Thus, an object whose movement direction is not fixed (that is, is indefinite) is highly likely to be the pedestrian waiting to cross the crosswalk. Thus, the boundary line between the first area and the second area can be accurately determined based on the position of an object whose movement direction is indefinite.
(8) In the above (7), the determination unit may be configured to determine a position of the boundary line, based on the position of the object identified by the identification unit. the pedestrian waiting to cross the crosswalk is highly likely to stay in the second area. Thus, the position of the boundary line between the first area and the second area can be accurately determined based on the position of the object whose movement direction is indefinite
(9) In any one of (1) to (8), the setting device may further include a display control unit configured to cause a display device to display the boundary line determined by the determination unit and the movement trajectory of the object generated by the generation unit. This enables the user to confirm whether the boundary line has been accurately determined based on the movement trajectory.
(10) A radio wave sensor according to the embodiment includes a transmitting and receiving unit configured to transmit a radio wave to an area including a crosswalk and receive a reflected wave of the radio wave from an object, a detection unit configured to detect a position of the object moving on the crosswalk, based on the reflected wave received by the transmitting and receiving unit, a generation unit configured to generate a movement trajectory of the object in a coordinate space set in advance in the radio wave sensor, based on the position of the object, and a determination unit configured to determine a detection area corresponding to the crosswalk in the coordinate space, based on the movement trajectory of the object. The detection area includes a first area including the crosswalk, and the determination unit is configured to determine a boundary line between the first area and a second area in which a passerby waits to cross the crosswalk, based on a movement trajectory of a vehicle traveling on a first roadway, the first roadway having a portion overlapping the crosswalk. The boundary line between the first area and the second area can be correctly determined based on the movement trajectory of the shape along the boundary line between the first area included in the roadway and the second area included in the sidewalk.
(11) In the above (10), the detection area may further include the second area. According to this configuration, the boundary line between the first area and the second area can be determined more correctly.
(12) A method for setting radio wave sensor according to the embodiment includes acquiring a detection result obtained by the radio wave sensor detecting an object moving on a crosswalk, generating a movement trajectory of the object in a coordinate space set in advance in the radio wave sensor, based on the detection result, and determining a detection area corresponding to the crosswalk in the coordinate space, based on the movement trajectory of the object. The detection area includes a first area including the crosswalk, and the determining includes determining a boundary line between the first area and a second area in which a passerby waits to cross the crosswalk, based on a movement trajectory of a vehicle traveling on a first roadway, the first roadway having a portion overlapping the crosswalk. The boundary line between the first area and the second area can be correctly determined based on the movement trajectory of the shape along the boundary line between the first area included in the roadway and the second area included in the sidewalk.
(13) In the above (12), the detection area may further include the second area. According to this method, the boundary line between the first area and the second area can be determined more correctly.
(14) A computer program according to the embodiment is a computer program for setting a radio wave sensor for detecting an object on a crosswalk, the computer program causing a computer to execute acquiring a detection result obtained by the radio wave sensor detecting the object moving on the crosswalk, generating a movement trajectory of the object in a coordinate space set in advance in the radio wave sensor, based on the detection result, and determining a detection area corresponding to the crosswalk in the coordinate space, based on the movement trajectory of the object. The detection area includes a first area including the crosswalk, and the determining includes determining a boundary line between the first area and a second area in which a passerby waits to cross the crosswalk, based on a movement trajectory of a vehicle traveling on a first roadway, the first roadway having a portion overlapping the crosswalk. The boundary line between the first area and the second area can be correctly determined based on the movement trajectory of the shape along the boundary line between the first area included in the roadway and the second area included in the sidewalk.
(15) In the above (14), the detection area may further include the second area. According to this configuration, the boundary line between the first area and the second area can be determined more correctly.

In the present disclosure, a part or all of the setting device for radio wave sensor can be configured as a semiconductor integrated circuit. In the present disclosure, a system including a setting device for a radio wave sensor can be configured.

### Details of Embodiments of Present Disclosure

Hereinafter, embodiments of the present disclosure will be described in detail with reference to the drawings. It is noted that, at least a part of the embodiments described below may be as desired combined.

### [1. Infrastructure Radio Wave Sensor]

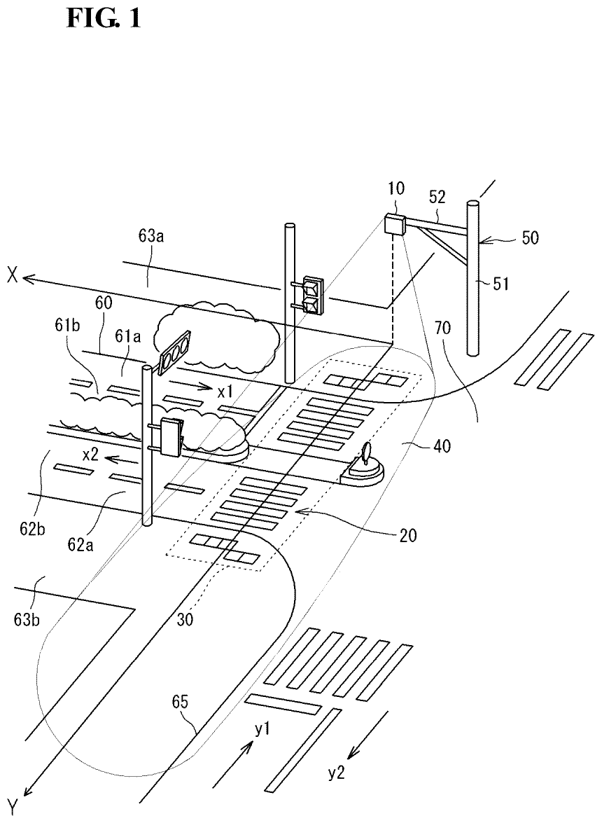

FIG. 1 is referenced. An infrastructure radio wave sensor 10 according to the embodiment as an example of the radio wave sensor is a radio wave radar for traffic monitoring. The infrastructure radio wave sensor 10 detects an object (a pedestrian, a bicycle, or a vehicle) in a crosswalk 20. The infrastructure radio wave sensor 10 is, for example, a millimeter wave radar.

The infrastructure radio wave sensor 10 is attached to a structure 50 provided on a road. The structure 50 has a height of several meters. The infrastructure radio wave sensor 10 is installed at a height of several meters above the ground. The structure 50 includes, for example, a pole 51 and an arm 52 provided near the upper end of the pole 51. The infrastructure radio wave sensor 10 is attached to the arm 52.

The infrastructure radio wave sensor 10 radiates a radio wave (millimeter wave) onto the crosswalk 20 and receives the reflected wave to detect an object (for example, a pedestrian or a bicycle) on the crosswalk 20. More specifically, the infrastructure radio wave sensor 10 can detect the distance from the infrastructure radio wave sensor 10 to the object on the crosswalk 20, the velocity of the object, and the horizontal angle (azimuth) with respect to the radio wave radiation axis at the position where the object is present.

The infrastructure radio wave sensor 10 is set with a detection area 30 that is the range on the road for detecting objects. The detection area 30 is a part of a radio wave radiation range 40 of the infrastructure radio wave sensor 10. The radio wave radiation range 40 covers the detection area 30. In order for the infrastructure radio wave sensor 10 to monitor the traffic situation of the entire crosswalk 20, the detection area 30 including the entire crosswalk 20 may be set. It is noted that, the radio wave radiation range 40 is a range in which the radio wave radiated by the infrastructure radio wave sensor 10 is reflected from an object and the infrastructure radio wave sensor 10 can detect the object by the reflected wave from the object. The radio wave radiation range 40 may not include a range in which the infrastructure radio wave sensor 10 cannot detect an object even though the radio wave can be radiated. However, the radio wave radiation range 40 is not limited to this, and may be the entire range in which the infrastructure radio wave sensor 10 can radiate radio waves.

The crosswalk 20 is provided on a roadway 60 in the vicinity of an intersection 70. At the intersection 70, the roadway 60 intersects with a roadway 65. Sidewalks 63a and 63b are provided adjacent to the roadway 60. The roadway 60 includes incoming lanes 61a and 61b where vehicles enter the intersection 70 and outgoing lanes 62a and 62b where vehicles exit the intersection 70. Hereinafter, the traveling direction of the vehicle in the incoming lanes 61a and 61b is referred to as an “x1 direction”. The traveling direction of the vehicle in the outgoing lanes 62a and 62b is referred to as an “x2 direction”. The traveling direction of the vehicle from the lower left to the upper right in the drawings on the roadway 65 is referred to as a “y1 direction”, and the traveling direction of the vehicle from the upper right to the lower left in the drawings on the roadway 65 is referred to as a “y2 direction”.

The incoming lane 61a, which is close to the sidewalk 63a, is a lane for straight and left turns. A vehicle traveling in the incoming lane 61a in the x1 direction goes straight and passes through the intersection 70, or turns left (changes the traveling direction to the y1 direction) and enters the roadway 65. An incoming lane 61b away from the sidewalk is a lane for going straight and turning right. A vehicle traveling in the incoming lane 61b in the x1 direction goes straight and passes through the intersection 70, or turns right (changes the traveling direction to the y2 direction) and enters the roadway 65. Vehicles traveling straight on the roadway 60 in the x2 direction and passing through the intersection 70, as well as vehicles traveling along the roadway 65 in the y1 direction and turn left at the intersection 70 enters the outgoing lane 62a close to the sidewalk. Vehicles traveling straight on the roadway 60 toward the x2 direction and passing through the intersection 70, as well as vehicles traveling along the roadway 65 in the y2 direction and turn right at the intersection 70 enters the outgoing lane 62b near the sidewalk.

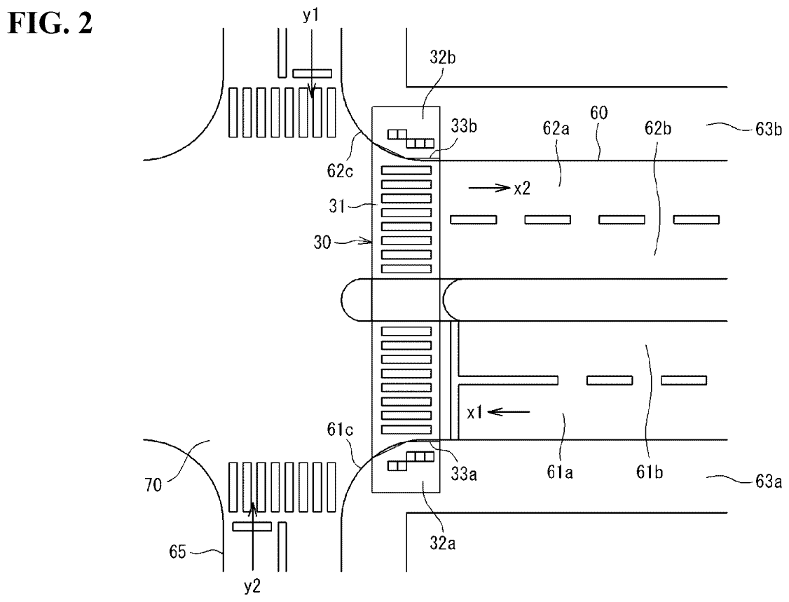

FIG. 2 is a diagram showing an example of a detection area. The detection area 30 includes a zebra crossing area 31, which is the area of the crosswalk 20, and waiting areas 32a and 32b where passersby (including pedestrians and bicycles) who cross the crosswalk 20 waiting to cross the crosswalk 20. The zebra crossing area 31 is an example of the “first area”. The waiting areas 32a and 32b are examples of “second area”. The waiting areas 32a and 32b are provided on both sides of the detection area 30 in the longitudinal direction (width direction of the roadway 60). In the example of FIG. 2, the waiting area 32a is set to the sidewalk 63a adjacent to the incoming lane 61a. A waiting area 32b is set to a sidewalk 63b adjacent to the outgoing lane 62a. The waiting area 32a is an example of a “first waiting area”. The waiting area 32b is an example of a “second waiting area”.

In the intersection 70, arc-shaped rounded corners 61c and 62c are provided at the connection point between the roadway 60 and the roadway 65. Specifically, the rounded corner 61c is provided at a connection point between the incoming lane 61a and the roadway 65, and a rounded corner 62c is provided at a connection point between the outgoing lane 62a and the roadway 65.

The crosswalk 20 is provided in a range from a straight portion of the roadway 60 to the middle of the rounded corners 61c and 62c. That is, the crosswalk 20 includes a portion of each of the rounded corners 61c and 62c.

In the detection area 30, a boundary line 33a between the zebra crossing area 31 and the waiting area 32a is set to have a shape along a boundary line between the roadway 60 and the sidewalk 63a. In the detection area 30, a boundary line 33b between the zebra crossing area 31 and the waiting area 32b is set to have a shape along a boundary line between the roadway 60 and the sidewalk 63b. The boundary line 33a has a shape along the boundary line between the incoming lane 61a and the sidewalk 63a, and includes a straight portion parallel to the incoming lane 61a and an inclined portion corresponding to the rounded corner 61c. The boundary line 33b has a shape along the boundary line between the outgoing lane 62a and the sidewalk 63b, and includes a straight portion parallel to the outgoing lane 62a and an inclined portion corresponding to the rounded corner 62c.

Referring back to FIG. 1, a coordinate space for detecting an object is set in advance in the infrastructure radio wave sensor 10. Hereinafter, the specific coordinate system set for the infrastructure radio wave sensor 10 is also referred to as the ‘inherent coordinate system’. For example, the inherent coordinate system is an orthogonal coordinate system that takes a point on the ground vertically below the infrastructure radio wave sensor 10 as the origin, with two horizontal axes orthogonal to each other designated as the X axis and Y axis. For example, the Y axis is an intersection line of a vertical plane including the radio wave radiation axis of the infrastructure radio wave sensor 10 (a normal direction of a radio wave radiation surface of the infrastructure radio wave sensor 10) and the ground. Hereinafter, the direction in which the intersection line extends from the origin to the radio wave radiation range 40 is also referred to as a “radio wave radiation direction”. The X-axis is an axis orthogonal to the Y-axis. The X-axis is an axis parallel to the ground.

In the infrastructure radio wave sensor 10, in order to accurately detect an object on the crosswalk 20, it is necessary to accurately set the detection area 30 in a coordinate space of the inherent coordinate system (hereinafter, also referred to as an “inherent coordinate space”). In the embodiment, the setting device determines the detection area 30 in the inherent coordinate space of the infrastructure radio wave sensor 10.

### [2. Hardware Configuration of Infrastructure Radio Wave Sensor]

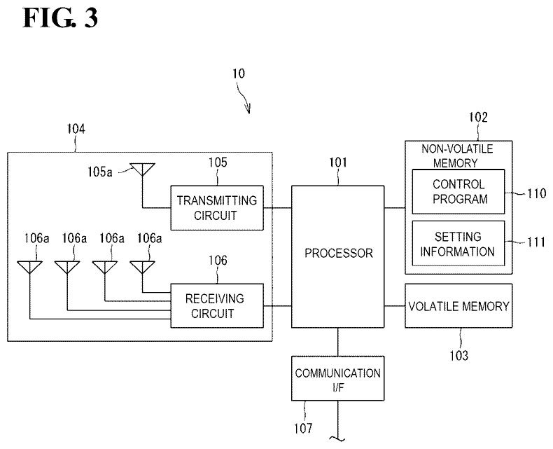

FIG. 3 is referenced. The infrastructure radio wave sensor 10 includes a processor 101, a non-volatile memory 102, a volatile memory 103, a transmitting and receiving unit 104, and a communication interface (communication I/F) 107.

The volatile memory 103 is a semiconductor memory such as a static random access memory (SRAM) or a dynamic random access memory (DRAM). The non-volatile memory 102 is, for example, a flash memory, a hard disk, a read only memory (ROM), or the like. The non-volatile memory 102 stores a control program 110, which is a computer program, and data used for executing the control program 110. Each function of the infrastructure radio wave sensor 10 is performed by the processor 101 executing the control program 110. The control program 110 can be stored in a recording medium such as a flash memory, a ROM, or a CD-ROM. The processor 101 can detect a position (distance and azimuth) as well as a velocity of the object by the control program 110.

The processor 101 is, for example, a central processing unit (CPU). However, the processor 101 is not limited to a CPU. The processor 101 may be a graphics processing unit (GPU). The processor 101 may be, for example, an application specific integrated circuit (ASIC) or a programmable logic device such as a gate array or a field programmable gate array (FPGA). In this case, the ASIC or the programmable logic device is configured to be able to execute the same processing as the control program 110.

The transmitting and receiving unit 104 includes a transmitting circuit 105 and a receiving circuit 106.

The transmitting circuit 105 includes a transmitting antenna 105a. It is noted that, the number of transmitting antennas 105a is not limited to one and may be plural. The transmitting circuit 105 generates a modulated wave and transmits the generated modulated wave from the transmitting antenna 105a. The transmitted modulated wave hits an object (for example, a pedestrian, a bicycle, or a vehicle) and is reflected.

The receiving circuit 106 includes a receiving antenna 106a. In order to detect the azimuth of the object, a plurality of (four in the drawing) receiving antennas 106a are provided. The receiving circuit 106 performs signal processing on the received reflected wave. The reflected wave data generated by the signal processing is supplied to the processor 101. The processor 101 analyzes the reflected wave data and detects the position (distance and azimuth) as well as velocity of the object.

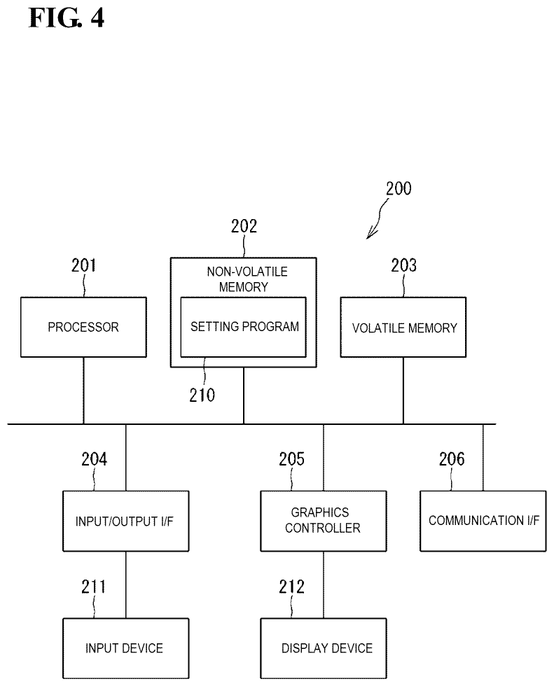

The communication I/F 107 can communicate with an external device. The communication I/F 107 is connected to a setting device 200 (see FIG. 4) via a cable, and can transmit the detection result to the setting device 200. The communication I/F 107 may be a wireless communication interface and may be capable of communicating with the setting device 200 wirelessly.

The non-volatile memory 102 stores setting information 111 of the detection area 30. The setting information 111 includes position information of the detection area 30 in the inherent coordinate space.

### [3. Configuration of Setting Device]

FIG. 4 is a block diagram showing an example of a hardware configuration of the setting device according to the embodiment. The setting device 200 according to the embodiment is used for setting the detection area 30 of the infrastructure radio wave sensor 10. The setting device 200 includes a processor 201, a non-volatile memory 202, a volatile memory 203, an input/output interface (I/F) 204, a graphics controller 205, and a communication interface (communication I/F) 206. The setting device 200 further includes an input device 211 and a display device 212. It is noted that, at least one of the input device 211 and the display device 212 may be an external device connected to the setting device 200.

The volatile memory 203 is a semiconductor memory such as an SRAM or a DRAM. The non-volatile memory 202 is, for example, a flash memory, a hard disk, a ROM, or the like. The non-volatile memory 202 stores a setting program 210 which is a computer program and data used for executing the setting program 210. Each function of the setting device 200 is performed by the processor 201 executing the setting program 210. The setting program 210 can be stored in a recording medium such as a flash memory, a ROM, or a CD-ROM. The processor 201 determines the detection area 30 of the infrastructure radio wave sensor 10 according to the setting program 210.

The processor 201 is, for example, a CPU. However, the processor 201 is not limited to a CPU. The processor 201 may be a GPU. The processor 201 may be, for example, an ASIC, or a programmable logic device such as a gate array or an FPGA. In this case, the ASIC or the programmable logic device is configured to be able to execute the same processing as the setting program 210.

For example, the input device 211 includes a keyboard and a pointing device such as a mouse. The input device 211 may be a capacitive or pressure-sensitive touch pad superimposed on the screen of the display device 212. The input device 211 is used for inputting data to the setting device 200. The input/output interface 204 is connected to the input device 211. The input/output interface 204 receives input data from the input device 211 and supplies the received data to the processor 201.

The display device 212 includes, for example, a liquid crystal panel or an organic electroluminescence (OEL) panel. The display device 212 can display textual or graphical information. The graphics controller 205 is connected to the display device 212 and controls display on the display device 212. The graphics controller 205 includes, for example, a GPU and a video RAM (VRAM), holds data to be displayed on the display device 212 in the VRAM, periodically reads video data for one frame from the VRAM, and generates a video signal. The generated video signal is output to the display device 212, and the video is displayed on the display device 212. The functions of the graphics controller 205 may be included in the processor 201. A part of the area of the volatile memory 203 may be used as a VRAM.

The communication I/F 206 can communicate with an external device. The communication I/F 206 is connected to the infrastructure radio wave sensor 10 by a communication cable, for example, and can communicate with the infrastructure radio wave sensor 10. The communication I/F 206 may be a wireless communication interface and may be capable of communicating with the infrastructure radio wave sensor 10 wirelessly. The communication I/F 206 may be capable of communicating with the infrastructure radio wave sensor 10 via a wide area network.

### [4. Functions of Infrastructure Radio Wave Sensor and Setting Device]

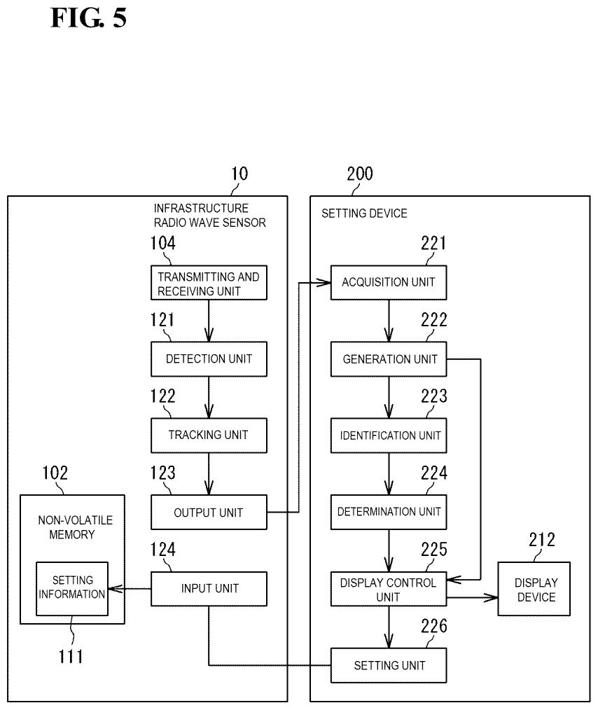

FIG. 5 is referenced. By executing the control program 110, the processor 101 enables the infrastructure radio wave sensor 10 to function as a detection unit 121, a tracking unit 122, an output unit 123, and an input unit 124. By executing the setting program 210, the processor 201 enables the setting device 200 functions as an acquisition unit 221, a generation unit 222, an identification unit 223, a determination unit 224, a display control unit 225, and a setting unit 226.

Radio waves are radiated to an object and reflected from the object. The detection unit 121 detects the position and the velocity of the object based on the reflected waves of the radio waves.

Specifically, the detection unit 121 generates reflected wave data indicating information including the signal level of the reflected wave for each position at which the radio wave is radiated. The transmitting circuit 105 transmits a transmission signal, which is a modulated wave, from the transmitting antenna 105a. The transmission signal from the transmitting antenna 105a hits an object and is reflected. The receiving antenna 106a receives a reflected wave from an object. The detection unit 121 combines the modulated wave signal output from the transmitting circuit 105 and the reflected wave signal output from the receiving circuit 106 to generate an intermediate frequency signal (hereinafter referred to as an “IF signal”). The detection unit 121 performs fast Fourier transform (FFT) on the IF signal to acquire information on distance, velocity, and azimuth. The detection unit 121 generates reflected wave data based on the acquired information of distance and azimuth.

The detection unit 121 extracts a reflection point which is a peak point included in the reflected wave data. The reflected wave data includes data indicating the waveform of the reflected wave for the distance and data indicating the waveform of the reflected wave for the angle. The detection unit 121 extracts a peak point from each of the waveform of the reflected wave for the distance and the waveform of the reflected wave for the angle. The detection unit 121 determines the reflection point by associating the peak point in the reflected wave for the distance with the peak point in the reflected wave for the angle.

The radio wave radiated from the infrastructure radio wave sensor 10 may be reflected from a plurality of objects at the same time. The detection unit 121 groups the reflection points of the same object. The detection unit 121 identifies a position of an object based on the reflected wave received by the receiving antenna 106a. The position of the object is represented as a coordinate value in the inherent coordinate system. Specifically, the detection unit 121 determines a representative value of the reflection points belonging to the same group, and sets the determined representative value to the position of the object. For example, the representative value is the centroid. However, the position of the object may be the representative value other than the centroid of the plurality of reflection points. For example, the representative value may be an average value of the reflection points or a median value of the reflection points.

A transmission signal (chirp) is transmitted from the transmitting antenna 105a at a constant interval. The moving object reflects the transmission signal at two different points, and the receiving antenna 106a receives each reflected wave. The detection unit 121 detects the velocity of the object from the phase difference between the pluralities of IF signals obtained from the moving object.

The tracking unit 122 tracks a detected object. Specifically, the tracking unit 122 assigns an ID to each object detected by the detection unit 121. The detection unit 121 outputs a detection result of the position and velocity of the object at a predetermined time interval. The tracking unit 122 distinguishes the same object as the previously detected object among the currently detected objects. For example, the tracking unit 122 estimates the current position of an object a based on the previous movement direction and velocity of the object a. The tracking unit 122 distinguishes, as the object a, an object whose position is closest to the position estimated from the previous movement direction and velocity of the object a among the objects detected this time. An object distinguished as the same as the previously detected object inherits the ID of the previously detected object.

The output unit 123 outputs the detection results of objects by the infrastructure radio wave sensor 10. The detection results include the position (distance and azimuth), the velocity, the ID, and the time information indicating the detection time of the object. The output unit 123 outputs the detection result of the object at a predetermined time interval.

The acquisition unit 221 acquires a detection result of an object output from the infrastructure radio wave sensor 10. The acquisition unit 221 acquires the detection result at a predetermined time interval.

The acquisition unit 221 accumulates the detection result of the acquired object. Specifically, the acquisition unit 221 registers the acquired detection result in a database (not shown) provided in the non-volatile memory 102. Thus, the detection result is accumulated in the database.

The generation unit 222 generates a movement trajectory of the object in the inherent coordinate space based on the detection result acquired by the acquisition unit 221.

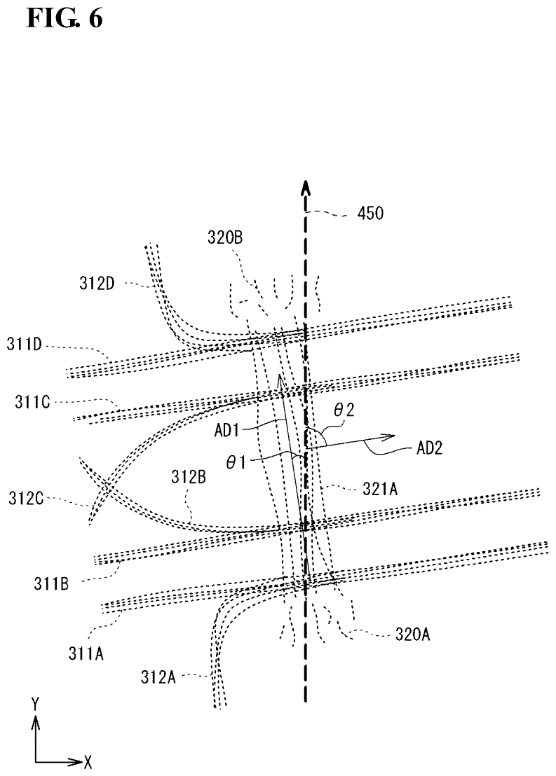

FIG. 6 is referenced. A movement trajectory 321A extending in the longitudinal direction of the crosswalk 20 (the direction orthogonal to the roadway 60 on which the crosswalk 20 is provided) is, for example, the movement trajectory of the passerby of the crosswalk 20. Movement trajectories 311A, 311B, 311C, 311D, 312A, 312B, 312C, and 312D extending in the width direction of the crosswalk 20 (the direction of the roadway 60 on which the crosswalk 20 is provided) are, for example, movement trajectories of vehicles traveling on the roadway 60. Movement trajectories 320A and 320B existing near both ends of the movement trajectory 321A are movement trajectories of pedestrians or bicycles waiting to cross the crosswalk 20 in the waiting areas 32a and 32b.

The movement trajectory 321A of the passerby to be moved may include the movement trajectories 320A and 320B of the waiting passerby. When the passerby waiting in the waiting area 32a or 32b starts to cross the crosswalk 20, the movement trajectory 321A in transit continues to the waiting movement trajectories 320A and 320B of passersby. In this case, the generation unit 222 can divide the waiting movement trajectories 320A and 320B of passersby and the passing movement trajectory 321A of passersby based on the detected position of the object included in the movement trajectory.

The movement trajectories 311A, 311B, 311C, 311D, 312A, 312B, 312C, and 312D of the vehicles include movement trajectories 311A, 311B, 311C, and 311D of the vehicles traveling straight through the intersection 70 and movement trajectories 312A, 312B, 312C, and 312D of the vehicles turning right or left in the intersection.

The movement trajectory 311A is a movement trajectory of the vehicle traveling straight in the x1 direction at the intersection 70 in the incoming lane 61a. A movement trajectory 311B is a movement trajectory of the vehicle traveling straight in the x1 direction of the intersection 70 in the incoming lane 61b. A movement trajectory 311C is a movement trajectory of the vehicle traveling straight in the x2 direction of the intersection 70 in the outgoing lane 62a. A movement trajectory 311D is a movement trajectory of the vehicle traveling straight in the x2 direction of the intersection 70 in the outgoing lane 62b.

The movement trajectory 312A is a movement trajectory of a vehicle that travels along the incoming lane 61a in the x1 direction, turns left at the intersection 70, and enters the roadway 65. A movement trajectory 312B is a movement trajectory of a vehicle that travels along the incoming lane 61b in the x1 direction, turns right at the intersection 70, and enters the roadway 65. A movement trajectory 312C is a movement trajectory of a vehicle that travels along the roadway 65 in the y2 direction, turns right at the intersection 70, and enters the outgoing lane 62b. A movement trajectory 312D is a movement trajectory of a vehicle that travels along the roadway 65 in the y1 direction, turns left at the intersection 70, and enters the outgoing lane 62a.

Detection results are output from the infrastructure radio wave sensor 10 at predetermined time intervals. When an object such as a pedestrian, a bicycle, or a vehicle moves, the position of the object detected by the infrastructure radio wave sensor 10 changes. For example, a set of positions (coordinates) of the same object at each time constitutes the movement trajectories 311A, 311B, 311C, 311D, 312A, 312B, 312C, 312D, 320A, 320B, and 321A. In another example, the generation unit 222 may constitute the moving trajectories 311A, 311B, 311C, 311D, 312A, 312B, 312C, 312D, 320A, 320B, and 321A as lines by connecting the positions in chronological order.

Referring back to FIG. 5, the identification unit 223 identifies the movement trajectories 311A, 311B, 311C, 311D, 312A, 312B, 312C, 312D of the vehicles traveling on the roadway 60 from the movement trajectories generated by the generation unit 222. The identification unit 223 identifies the movement trajectory 321A of the passerby crossing the crosswalk 20 from the movement trajectories generated by the generation unit 222. The identification unit 223 identifies the movement trajectories 320A and 320B of the passerby waiting to cross the crosswalk 20 in the waiting areas 32a and 32b from the movement trajectories generated by the generation unit 222.

For example, the identification unit 223 can distinguish the movement trajectories 321A, 320A, and 320B of the passerby from the movement trajectories 311A, 311B, 311C, 311D, 312A, 312B, 312C, and 312D of the vehicle based on the movement velocity of the object.

For example, the identification unit 223 distinguishes the movement trajectory 321A of the passerby passing through the crosswalk, the movement trajectories 320A and 320B of the passersby waiting to pass through the crosswalk, and the movement trajectories 311A, 311B, 311C, 311D, 312A, 312B, 312C, and 312D of the vehicles.

For example, the identification unit 223 groups movement trajectories that are oriented in substantially the same direction. Thus, for example, the movement trajectory 321A is grouped, and the movement trajectories 311A, 311B, 311C, 311D, 312A, 312B, 312C, and 312D are grouped. Hereinafter, the group of the movement trajectory 321A is referred to as a “group A”. A group of the movement trajectories 311A, 311B, 311C, 311D, 312A, 312B, 312C, and 312D is referred to as a “group B”. The identification unit 223 can use the movement velocity of the object in addition to the direction of the movement trajectory in identifying the groups A and B.

The identification unit 223 determines the movement direction of each of the groups A and B. For example, for the group A of the movement trajectory of passerby, the identification unit 223 extracts the direction of the straight portion of each of the movement trajectories 320A, 320B, and 321A, and calculates the average value of the extracted directions. The calculated average value is set as a representative direction AD1 of the group A (see FIG. 6). For the group B of the movement trajectory of the vehicle, the identification unit 223 extracts the direction of the straight portion of each of the movement trajectories 311A, 311B, 311C, 311D, 312A, 312B, 312C, and 312D, and calculates the average value of the extracted directions. The calculated average value is set as a representative direction AD2 of the group B (see FIG. 6).

The infrastructure radio wave sensor 10 is installed such that the angle between a radio wave radiation direction 450 of the infrastructure radio wave sensor 10 and the y1 direction which is a longitudinal direction of the crosswalk 20 is minimized. For example, the angle ψ between the radio wave radiation direction 450 and the longitudinal direction of the crosswalk 20, −45 degree <ψ<45 degree is satisfied. Thus, an angle θ1 between the representative direction AD1 of the group A and the radio wave radiation direction 450 is smaller than an angle θ2 between the representative direction AD2 of the group B and the radio wave radiation direction 450. The identification unit 223 compares an angle θ1 between the representative direction AD1 of the group A and the radio wave radiation direction 450 with an angle θ2 between the representative direction AD2 of the group B and the radio wave radiation direction 450. The identification unit 223 identifies the group A corresponding to the smaller angle θ1 as the group of the movement trajectory of the passerby who is traveling on the crosswalk 20, and identifies the group B corresponding to the larger angle θ2 as the group of the movement trajectory of the vehicle.

The identification unit 223 groups the movement trajectories 311A, 311B, 311C, and 311D having a linear shape among the movement trajectories of the group B, and groups the movement trajectories 312A, 312B, 312C, and 312D having a curved shape. This grouping is performed based on the shape of the movement trajectory. Hereinafter, a group of the movement trajectories 311A, 311B, 311C, and 311D is referred to as a “group B1”, and a group of the movement trajectories 312A, 312B, 312C, and 312D is referred to as a “group B2”. The group B1 is a group of movement trajectories of vehicles traveling straight through the intersection 70. The group B2 is a group of the movement trajectories of the vehicle turning right or left at the intersection 70.

The identification unit 223 identifies the movement trajectory 312A of the vehicle that travels along the roadway 65 in the y1 direction, turns left at the intersection 70, and enters the outgoing lane 62a in the group B2. The identification unit 223 identifies the movement trajectory 312B of a vehicle that travels along the roadway 65 in the y2 direction, turns right at the intersection 70, and enters the outgoing lane 62b. The identification unit 223 identifies as well as the movement trajectory 312C of a vehicle that travels along the incoming lane 61b in the x1 direction and turns right at the intersection 70 to enter the roadway 65. The identification unit 223 identifies the movement trajectory 312D of the vehicle that travels along the incoming lane 61b in the x1 direction, turns left at the intersection 70, and enters the roadway 65. The position and the movement direction of the movement trajectory are used to identify the movement trajectories 312A, 312B, 312C, and 312D.

Further, the identification unit 223 identifies the movement trajectory of the passerby waiting to cross the crosswalk. Specifically, the identification unit 223 identifies moving trajectories with an indefinite movement direction (that is, moving trajectories that are either hardly moving or frequently change movement direction). For example, the identification unit 223 identifies the movement trajectory of an object that exists for a certain period of time in a certain area (an area around both ends of the movement trajectory 321A). Thus, the movement trajectories 320A and 320B are identified. Hereinafter, a group of the movement trajectories 320A and 320B is referred to as a “group C”. The movement trajectories 320A and 320B represent the movement trajectories of passersby waiting in the waiting area to cross the crosswalk 20. Thus, the movement trajectories 320A and 320B are a set of positions of objects detected by the infrastructure radio wave sensor 10 in a certain area (a waiting area to cross the crosswalk 20).

The determination unit 224 determines a detection area in the inherent coordinate space based on the movement trajectory of the object generated by the generation unit 222. For example, the determination unit 224 can determine the detection area based on the group A, the group B1, the group B2, and the group C identified by the identification unit 223.

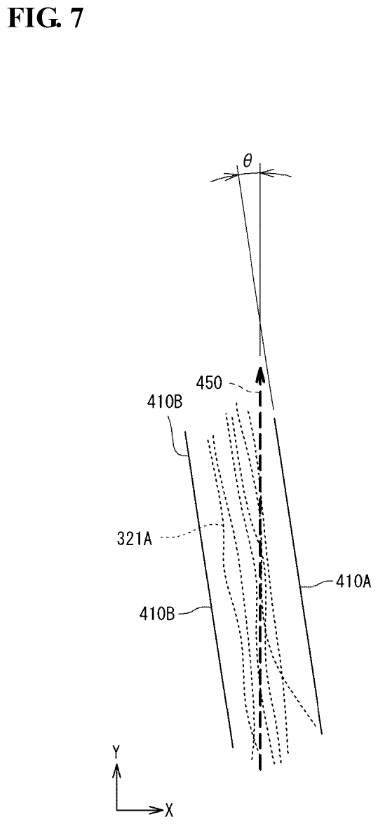

The determination unit 224 determines a definition line along the longitudinal direction of the crosswalk 20 among a plurality of lines (hereinafter, referred to as “definition lines”) defining the detection area based on the group A. FIG. 7 is a diagram for explaining an example of determination of a definition line along the longitudinal direction of a crosswalk. The definition lines along the longitudinal direction of the crosswalk 20 are lines perpendicular to the width direction of the detection area. Hereinafter, the definition lines along the longitudinal direction of the crosswalk 20 are referred to as a “first definition line 410A” and a “second definition line 410B”.

The determination unit 224 determines, for example, the first definition line 410A and the second definition line 410B as lines extending in the representative direction AD1 of the movement trajectory 321A belonging to the group A. Further, the determination unit 224, for example, determines the positions of the first definition line 410A and the second definition line 410B based on the range in which the movement trajectories 321A belonging to the group A are distributed. In a specific example, the determination unit 224 can determine the position of the first definition line 410A based on the movement trajectory positioned at the rightmost side of the group A. The determination unit 224 may determine the position of the second definition line 410B based on movement trajectory positioned at the leftmost side of the group A.

For example, the determination unit 224 can determine the first definition line 410A and the second definition line 410B as lines extending in the representative direction AD1 obtained from the group A. That is, the determination unit 224 can determine the first definition line 410A and the second definition line 410B as straight lines inclined by θ1 to the radio wave radiation direction 450.

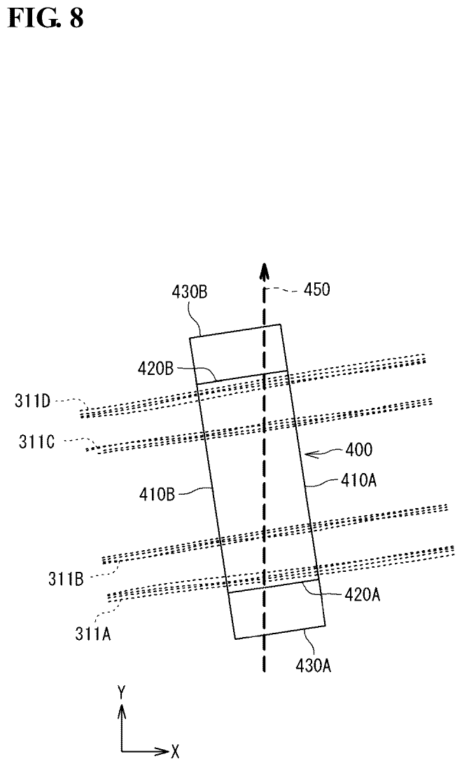

The determination unit 224 temporarily arranges the definition line along the width direction of the crosswalk 20 in the inherent coordinate space based on the group B1. FIG. 8 is referenced. The definition line along the width direction of the crosswalk 20 includes lines on both sides of a detection area 400 in the longitudinal direction and boundary lines between a zebra crossing area 401 and the waiting areas 402A and 402B. Definition lines on both sides in the longitudinal direction of the detection area 400 are referred to as a “third definition line” and a “fourth definition line”. A boundary line between the zebra crossing area 401 and the waiting area 402A is referred to as a “first boundary line”. A boundary line between the zebra crossing area 401 and a waiting area 402B is referred to as a “second boundary line”.

The determination unit 224 tentatively determines, for example, a third definition line 430A and a fourth definition line 430B, as well as a first boundary line 420A and a second boundary line 420B as straight lines extending in the representative direction AD2 of the movement trajectories 311A, 311B, 311C, and 311D belonging to the group B1. The positions and shapes of the tentatively determined third definition line 430A and the fourth definition line 430B, as well as the first boundary line 420A and the second boundary line 420B can be changed in the subsequent processing.

The third definition line 430A and the fourth definition line 430B are tentatively determined as straight lines parallel to each other. The first boundary line 420A and the second boundary line 420B are tentatively determined as straight lines parallel to each other.

The determination unit 224 tentatively determines the positions of the third definition line 430A, the fourth definition line 430B, as well as the first boundary line 420A and the second boundary line 420B based on the range in which the movement trajectories 311A, 311B, 311C, and 311D belonging to the group B1 are distributed, for example. In a specific example, the determination unit 224 can tentatively determine the positions of the first boundary line 420A and the third definition line 430A based on the position of the movement trajectory 311A of the vehicle moving in the lane 61a in the group B1. For example, the temporary position of the third definition line 430A can be set in advance in a position at a distance apart from the first boundary line 420A. The determination unit 224 can tentatively determine the positions of the second boundary line 420B and the fourth definition line 430B based on the position of the movement trajectory 311D of the vehicle moving in the lane 61a in the group B1. For example, the temporary position of the fourth definition line 430B can be set in advance at a position at a distance apart from the second boundary line 420B.

The determination unit 224 determines the first boundary line and the second boundary line based on the movement trajectories 312A, 312B, 312C, and 312D belonging to the group B2. In a specific example, the determination unit 224 determines the shapes of the first boundary line and the second boundary line based on the movement trajectories 312A, 312B, 312C, and 312D belonging to the group B2. In other words, the determination unit 224 corrects the shapes of the tentatively determined first boundary line and second boundary line based on the movement trajectories 312A, 312B, 312C, and 312D belonging to the group B2.

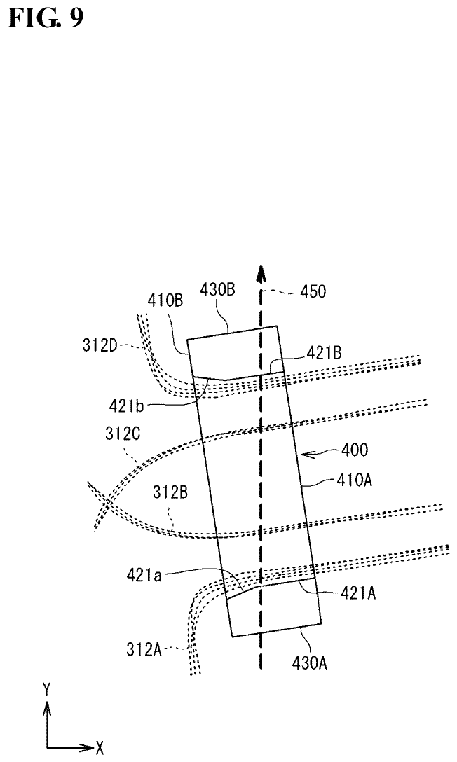

FIG. 9 is referenced. For example, the determination unit 224 determines the first boundary line based on the movement trajectory 312A of the vehicle that turns left on the incoming lane 61a and enters the roadway 65. The movement trajectory 312A is an example of a “first movement trajectory”.

Specifically, the determination unit 224 determines the radius of curvature and the center position of the curved portion of the movement trajectory 312A. For example, the determination unit 224 determines a representative trajectory representing the movement trajectory 312A. The representative trajectory is, for example, an average movement trajectory of the plurality of movement trajectories 312A. The determination unit 224 calculates an arc approximating the curved portion of the representative trajectory and sets the radius of the arc as the radius of curvature of the movement trajectory 312A. The determination unit 224 also sets the center of the calculated circular arc as the center position of the movement trajectory 312A.

The determination unit 224 determines the shape of a first boundary line 421A based on the radius of curvature and the center position of the movement trajectory 312A. In a specific example, the determination unit 224 determines an angle of an inclined portion 421a of the first boundary line 421A based on the center position of the movement trajectory 312A, and determines a position of the inclined portion 421a of the first boundary line 421A based on the radius of curvature of the movement trajectory 312A. For example, the position of the inclined portion 421a can be determined to be further away from the center position as the radius of curvature is increased.

For example, the determination unit 224 can determine the shape of the first boundary line 421A based on the movement trajectory 312B of the vehicle that turns right on the incoming lane 61b and enters the roadway 65. In a specific example, the determination unit 224 determines a radius of curvature and a center position of a curved portion of the movement trajectory 312B. The determination unit 224 calculates an average value of the radius of curvature of the movement trajectories 312A and 312B. The determination unit 224 calculates the average value of the center positions of the movement trajectories 312A and 312B. The determination unit 224 may determine the angle of the inclined portion 421a based on the calculated average value of the center position. The determination unit 224 may determine the position of the inclined portion 421a based on the calculated average value of the radius of curvature.

For example, the determination unit 224 determines a second boundary line 421B based on the movement trajectory 312D of the vehicle that turns left on the roadway 65 and enters the outgoing lane 62a. In a specific example, the movement trajectory 312D is an example of a “second movement trajectory”. The determination unit 224 determines the shape of the second boundary line 421B based on the radius of curvature and the center position of the movement trajectory 312D. It is noted that, the determination of the shape of the second boundary line 421B using the radius of curvature and the center position is the same as the determination of the shape of the first boundary line 421A. That is, the determination unit 224 can determine an angle and a position of an inclined portion 421b of the second boundary line 421B.

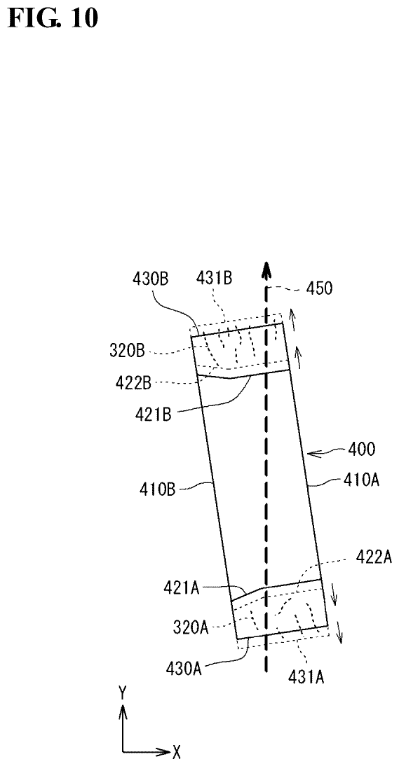

The determination unit 224 determines the first boundary line and the second boundary line further based on the movement trajectories 320A and 320B belonging to the group C. FIG. 10 is a diagram for explaining an example of determining the positions of the first boundary line and the second boundary line.

In a specific example, the determination unit 224 determines the positions of the first boundary line and the second boundary line based on the movement trajectories 320A and 320B belonging to the group C. In other words, the determination unit 224 corrects the positions of the first boundary line and the second boundary line that have been tentatively determined, based on the movement trajectories 320A and 320B belonging to the group C.

For example, the determination unit 224 calculates an average value of a plurality of positions included in the movement trajectory 320A belonging to the group C. The determination unit 224 determines the position of a first boundary line 422A based on the calculated average position. For example, the offset amount of the first boundary line from the average position of the movement trajectory 320A belonging to the group C is determined in advance. The determination unit 224 can determine a position spaced apart from the average position of the movement trajectory 320A belonging to the group C by an offset amount as the position of the first boundary line 422A.

The determination unit 224 shifts the first boundary line 422A from the tentatively determined position to the position determined by the determination unit 224 in the inherent coordinate space. In one example, a third definition line 431A can be set in advance to position at a distance apart from the first boundary line 422A. Thus, the determination unit 224 shifts the third definition line 431A from the tentatively determined position by the same movement amount and movement direction as the first boundary line 422A. Similarly, the determination unit 224 determines the positions of a second boundary line 422B and a fourth definition line 431B based on the average position of a movement trajectory 320B belonging to the group C. As described above, the detection area 400 is determined by the determination unit 224.

Referring back to FIG. 5, when a median strip 25 is provided in the crosswalk 20, the determination unit 224 may determine a median strip area as a sub-area of the detection area 400 based on the movement trajectory of the vehicle traveling on the roadway 60.

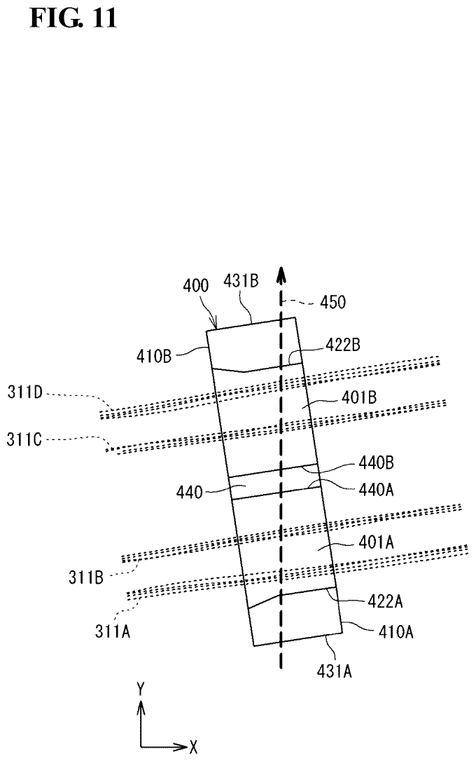

FIG. 11 is a diagram for explaining an example of determination of a median strip area. A median strip area 440 is provided in the middle of the detection area 400 in the longitudinal direction, and divides the zebra crossing area into a first zebra crossing area 401A and a second zebra crossing area 401B. That is, the median strip area 440 is arranged between the first zebra crossing area 401A and the second zebra crossing area 401B.

For example, the determination unit 224 determines a third boundary line 440A which is a boundary line between the median strip area 440 and the first zebra crossing area 401A and a fourth boundary line 440B which is a boundary line between the median strip area 440 and the second zebra crossing area 401B. More specifically, the determination unit 224 determines the positions of the third boundary line 440A and the fourth boundary line 440B based on the movement trajectories 311A, 311B, 311C, and 311D belonging to the group B1. The third boundary line 440A and the fourth boundary line 440B are straight lines parallel to the third definition line 431A and the fourth definition line 431B.

In a specific example, the determination unit 224 can determine the position of the third boundary line 440A based on the movement trajectory 311B of the vehicle traveling straight on the incoming lane 61b and determine the position of the fourth boundary line 440B based on the movement trajectory 311C of the vehicle traveling straight on the outgoing lane 62b. For example, the determination unit 224 can arrange the third boundary line 440A and the fourth boundary line 440B at a predetermined interval in the center between the movement trajectory 311B of the vehicle traveling on the incoming lane 61b and the movement trajectory 311C of the vehicle traveling on the outgoing lane 62b.

The determination unit 224 may determine the positions of the third boundary line 440A and the fourth boundary line 440B based on the group B2 instead of the group B1 or in addition to the group B1. Specifically, the determination unit 224 may determine the position of the third boundary line 440A based on the movement trajectory 312B of the vehicle that turns right on the incoming lane 61b and enters the roadway 65. The determination unit 224 may determine the position of the fourth boundary line 440B based on the movement trajectory 312C of the vehicle that turns right on the roadway 65 and enters the outgoing lane 62b.

Referring back to FIG. 5, the display control unit 225 displays the first boundary line 422A and the second boundary line 422B determined by the determination unit 224 and the movement trajectories 311A, 311B, 311C, 311D, 312A, 312B, 312C, 312D, 320A, 320B and 321A of the objects generated by the generation unit 222 on the display device 212. More specifically, the display control unit 225 superimposes and displays the detection area 400 determined by the determination unit 224 and the movement trajectories 311A, 311B, 311C, 311D, 312A, 312B, 312C, 312D, 320A, 320B, and 321A of objects generated by the generation unit 222 on the display device 212.

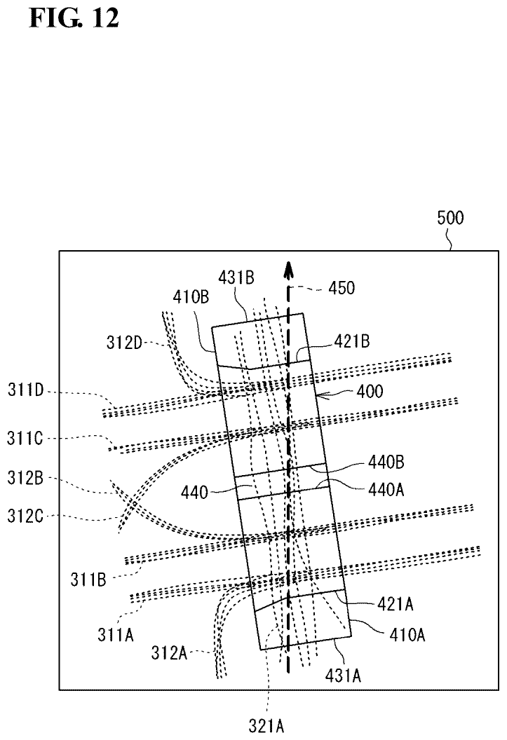

FIG. 12 is referenced. A confirmation screen 500 is a screen for the user to confirm the detection area 400 determined by the setting device 200. On the confirmation screen 500, the detection area 400 and the movement trajectories 311A, 311B, 311C, 311D, 312A, 312B, 312C, 312D, 320A, 320B, and 321A are superimposed and displayed. This enables the user to confirm whether the shape and position of the detection area 400 are appropriate.

For example, the user can input approval or rejection of the displayed detection area 400 to the setting device 200 using the input device 211. The rejected detection area 400 is discarded.

Referring back to FIG. 5, the setting unit 226 sets the approved detection area 400 in the infrastructure radio wave sensor 10. Specifically, the setting unit 226 generates setting information 111 indicating the approved detection area 400, and outputs the generated setting information 111 to the infrastructure radio wave sensor 10.

The input unit 124 receives the setting information 111 output from the setting device 200. The input unit 124 stores the received setting information 111 in the non-volatile memory 102. Thus, the detection area 400 is set in the infrastructure radio wave sensor 10.

### [5. Setting Operation of Infrastructure Radio Wave Sensor and Setting Device]

Hereinafter, operations of the infrastructure radio wave sensor 10 and the setting device 200 for setting the detection area in the infrastructure radio wave sensor 10 will be described.

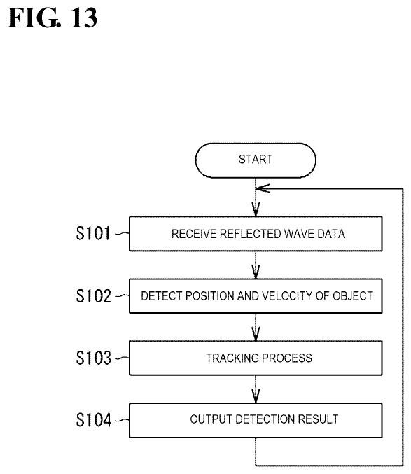

FIG. 13 is a flowchart showing an example of the operation of the infrastructure radio wave sensor according to the embodiment.

When the processor 101 starts the control program 110, the infrastructure radio wave sensor 10 executes the processes described below.

The transmitting circuit 105 generates a modulated wave and transmits the generated modulated wave from the transmitting antenna 105a. The transmitted modulated wave hits an object (a pedestrian, a bicycle, or a vehicle), and the receiving antenna 106a receives the reflected wave from the object. The receiving circuit 106 processes the reflected wave signal and generates reflected wave data. The processor 101 receives the reflected wave (step S101).

The processor 101 analyzes the reflected wave data and detects a reflection point. The processor 101 groups reflection points in the same object and detects the position and velocity of the object (step S102).

The processor 101 distinguishes the same object as the previously detected object among the currently detected objects (step S103). An object distinguished as the same as the previously detected object inherits the ID of the previously detected object.

The processor 101 outputs a detection result including the position, the velocity, and the ID of the object (step S104), and returns to step S101. As described above, the detection result is output from the infrastructure radio wave sensor 10 at a constant cycle.

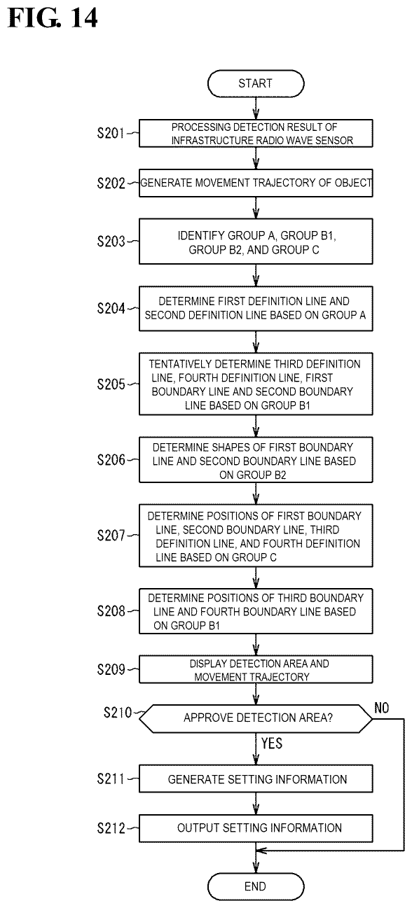

FIG. 14 is a flowchart showing an example of the operation of the setting device according to the embodiment.

When the processor 201 starts the setting program 210, the setting device 200 executes the processes described below.

The processor 201 acquires the detection result output from the infrastructure radio wave sensor 10 (step S201). The infrastructure radio wave sensor 10 continuously outputs detection results, and the processor 201 receives these detection results. The acquired detection result is stored in the database, and the detection result is accumulated.

The processor 201 generates a movement trajectory of the object from the detection result acquired from the infrastructure radio wave sensor 10 (step S202).

The processor 201 identifies each of the group A, the group B1, the group B2, and the group C from the plurality of generated movement trajectories (step S203).

The processor 201 determines the first definition line 410A and the second definition line 410B of the detection area 400 based on the group A (step S204).

The processor 201 tentatively determines the third definition line 430A and the fourth definition line 430B, as well as the first boundary line 420A and the second boundary line 420B of the detection area 400 based on the group B1 (step S205).

The processor 201 determines the shapes of the first boundary line 421A and the second boundary line 421B based on the group B2 (step S206).

The processor 201 determines the positions of the first boundary line 422A, the second boundary line 422B, the third definition line 431A, and the fourth definition line 431B based on the group C (step S207).

The processor 201 determines the positions of the third boundary line 440A and the fourth boundary line 440B based on the group B1 (step S208).

The processor 201 superimposes and displays the determined detection area 400 and the movement trajectory of the object on the display device 212 (step S209).

The user compares the position and shape of the displayed detection area 400 with the position and shape of the movement trajectory, and determines whether the detection area 400 is appropriate. When the detection area 400 is appropriate, the user inputs approval of the detection area 400 to the setting device 200 by the input device 211, and when the detection area 400 is not appropriate, the user inputs rejection of the detection area 400 to the setting device 200 by the input device 211 (step S210).

When rejection of the detection area 400 is input (NO in step S210), the processor 201 ends the processing.

When the approval of detection area 400 is input (YES in step S210), processor 201 generates setting information 111 indicating the determined detection area 400 (step S211). The processor 201 outputs the generated setting information 111 to the infrastructure radio wave sensor 10 (step S212), and ends the processing. The infrastructure radio wave sensor 10 writes the input setting information 111 in the non-volatile memory 102. Thus, the setting of the detection area in the infrastructure radio wave sensor 10 is completed.

### [6. Modifications]

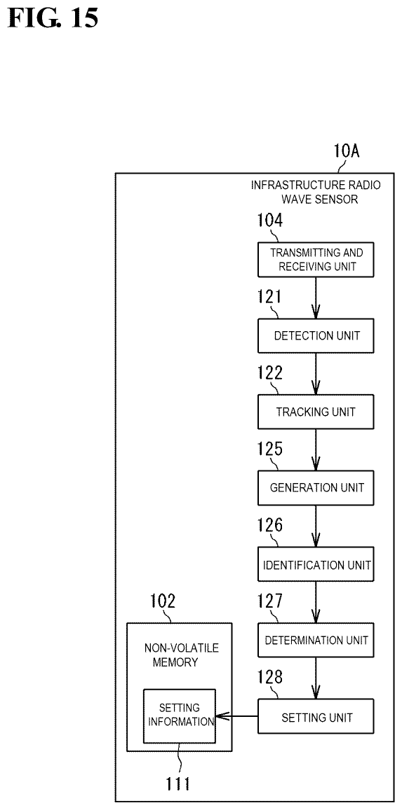

Each function for determining the detection area of the setting device 200 may be provided in the infrastructure radio wave sensor. FIG. 15 is a functional block diagram showing one modification of the functionality of the infrastructure radio wave sensor according to an embodiment.

An infrastructure radio wave sensor 10A according to the modification has the functions of a generation unit 125, an identification unit 126, a determination unit 127, and a setting unit 128 in addition to the functions of the detection unit 121 and the tracking unit 122.

The generation unit 125 generates a movement trajectory of the object based on the detection result of the object to which the ID is assigned by the tracking unit 122.

The detailed functions of the generation unit 125 are the same as those of the generation unit 222, and thus the description thereof is omitted.

The identification unit 126 identifies each of the group A, the group B1, the group B2, and the group C from the movement trajectory generated by the generation unit 125. The detailed functions of the identification unit 126 are the same as those of the identification unit 223, and thus the description thereof is omitted.

The determination unit 127 determines a detection area in the inherent coordinate space based on the movement trajectory of the object generated by the generation unit 125. The detailed functions of the determination unit 127 are the same as those of the determination unit 224, and thus the description thereof is omitted.

The setting unit 128 sets the determined detection area in the infrastructure radio wave sensor 10A. Specifically, the setting unit 128 generates setting information 111 indicating the detection area 400, and stores the generated setting information 111 in the non-volatile memory 102.

According to the infrastructure radio wave sensor 10A of the present modification, the detection area can be automatically determined and automatically set without the need for the setting device 200.

The function of the determination unit 224 described above is an example, and the present disclosure is not limited thereto. For example, the determination unit 224 determines the positions of the first boundary line and the second boundary line based on the group C, but the present disclosure is not limited thereto. For example, the determination unit 224 may determine the positions of the first boundary line and the second boundary line based on the group B2. Specifically, the determination unit 224 can determine the position of a first boundary line that is close to the movement trajectory 312A of a vehicle that turns left from the incoming lane 61a to enter the roadway 65, based on the movement trajectory 312A in the group B2, and can also determine the position of the second boundary line that is close to the movement trajectory 312D of a vehicle that turns left into the outgoing lane 62a from the roadway 65, based on the movement trajectory 312D. As another example, the determination unit 224 may determine the positions of the first boundary line and the second boundary line based on the group B2 and the group C.

The embodiments disclosed herein are illustrative and non-restrictive in all respects. The scope of the present invention is defined by the appended claims rather than the foregoing embodiments, and includes all modifications within the scope of the claims and the equivalents thereof.

### REFERENCE SIGNS LIST

10, 10A infrastructure radio wave sensor
20 crosswalk
30, 400 detection area
31, 401 zebra crossing area
32a, 32b, 402A, 402B waiting area
33a, 33b boundary line
40 radio wave radiation range
50 structure
51 pole
52 arm
63a, 63b sidewalk
60, 65 roadway
61a, 61b incoming lane
62a, 62b outgoing lane
61c, 62c rounded corner
70 intersection
101 processor
102 non-volatile memory
103 volatile memory
104 transmitting and receiving unit
105 transmitting circuit
106 receiving circuit
105a transmitting antenna
106a receiving antenna
107 communication interface (communication I/F)
110 control program
111 setting information
121 detection unit
122 tracking unit
123 output unit
124 input unit
200 setting device
201 processor
202 non-volatile memory
203 volatile memory
204 input/output interface (I/O)
205 graphics controller
206 communication interface (communication I/F)
210 setting program
211 input device
212 display device
221 acquisition unit
222, 125 generation unit
223, 126 identification unit
224, 127 determination unit
225 display control unit
226, 128 setting unit
311A, 311B, 311C, 311D, 312A, 312B, 312C, 312D, 320A, 320B, 321A movement trajectory
450 radio wave radiation direction
401A first zebra crossing area
401B second zebra crossing area
410A first definition line
410B second definition line
420A, 421A, 422A first boundary line
420B, 421B, 422B second boundary line
421a, 421b inclined portion
430A, 431A third definition line
430B, 431B fourth definition line
440 median strip area
440A third boundary line
440B fourth boundary line
500 confirmation screen

1. A setting device for a radio wave sensor, comprising:
an acquisition circuitry configured to acquire a detection result obtained by the radio wave sensor detecting an object moving on a crosswalk;
a generation circuitry configured to generate a movement trajectory of the object in a coordinate space set in advance in the radio wave sensor, based on the detection result; and
a determination circuitry configured to determine a detection area corresponding to the crosswalk in the coordinate space, based on the movement trajectory of the object, wherein
the detection area includes a first area including the crosswalk, and
the determination circuitry is configured to determine a boundary line between the first area and a second area in which a passerby waits to cross the crosswalk, based on a movement trajectory of a vehicle traveling on a first roadway, the first roadway having a portion overlapping the crosswalk.

2. The setting device for a radio wave sensor according to claim 1, wherein
the detection area further includes the second area.

3. The setting device for a radio wave sensor according to claim 1, wherein
the determination circuitry is configured to determine the boundary line, based on a movement trajectory of a vehicle turning right or left at an intersection between the first roadway and a second roadway intersecting the first roadway.

4. The setting device for a radio wave sensor according to claim 3, wherein
the determination circuitry is configured to determine a shape of the boundary line, based on the movement trajectory of the vehicle turning right or left at the intersection.

5. The setting device for a radio wave sensor according to claim 3, wherein
the detection area includes, as the second area, a first waiting area and a second waiting area, the first waiting area being in contact with an incoming lane where a vehicle is to enter the intersection on the first roadway, the second waiting area being in contact with an outgoing lane where a vehicle exits the intersection on the first roadway, and
the determination circuitry is configured to:
determine a first boundary line based on a first movement trajectory, the first boundary line being a boundary line between the first area and the first waiting area, the first movement trajectory being a movement trajectory of a vehicle turning left or right on the incoming lane and entering the second roadway; and
determine a second boundary line based on a second movement trajectory, the second boundary line being a boundary line between the first area and the second waiting area, the second movement trajectory being a movement trajectory of a vehicle turning left or right on the second roadway and entering the outgoing lane.

6. The setting device for a radio wave sensor according to claim 1, wherein
the determination circuitry is configured to determine the boundary line, based further on a detection position of a passerby waiting to cross the crosswalk, the detection position being detected by the radio wave sensor.

7. The setting device for a radio wave sensor according to claim 6, further comprising
an identification circuitry configured to identify an object whose movement direction is indefinite, based on a plurality of the detection results acquired from the radio wave sensor by the acquisition circuitry, wherein
the determination circuitry is configured to determine the boundary line, based on a position of the object identified by the identification circuitry.

8. The setting device for a radio wave sensor according to claim 7, wherein
the determination circuitry is configured to determine a position of the boundary line, based on the position of the object identified by the identification circuitry.

9. The setting device for a radio wave sensor according to claim 1, further comprising
a display control circuitry configured to cause a display device to display the boundary line determined by the determination circuitry and the movement trajectory of the object generated by the generation circuitry.

10. A radio wave sensor comprising:
a transmitting and receiving circuitry configured to transmit a radio wave to an area including a crosswalk and receive a reflected wave of the radio wave from an object;
a detection circuitry configured to detect a position of the object moving on the crosswalk, based on the reflected wave received by the transmitting and receiving circuitry;
a generation circuitry configured to generate a movement trajectory of the object in a coordinate space set in advance in the radio wave sensor, based on the position of the object; and
a determination circuitry configured to determine a detection area corresponding to the crosswalk in the coordinate space, based on the movement trajectory of the object, wherein
the detection area includes a first area including the crosswalk, and
the determination circuitry is configured to determine a boundary line between the first area and a second area in which a passerby waits to cross the crosswalk, based on a movement trajectory of a vehicle traveling on a first roadway, the first roadway having a portion overlapping the crosswalk.

11. The radio wave sensor according to claim 10, wherein
the detection area further includes the second area.

12. A method for setting a radio wave sensor, comprising:
acquiring a detection result obtained by the radio wave sensor detecting an object moving on a crosswalk;
generating a movement trajectory of the object in a coordinate space set in advance in the radio wave sensor, based on the detection result; and
determining a detection area corresponding to the crosswalk in the coordinate space, based on the movement trajectory of the object, wherein
the detection area includes a first area including the crosswalk, and
the determining includes determining a boundary line between the first area and a second area in which a passerby waits to cross the crosswalk, based on a movement trajectory of a vehicle traveling on a first roadway, the first roadway having a portion overlapping the crosswalk.

13. The method for setting a radio wave sensor according to claim 12, wherein
the detection area further includes the second area.

14. A non-transitory computer-readable storage medium storing a computer program for setting a radio wave sensor for detecting an object on a crosswalk,
the computer program causing a computer to execute:
acquiring a detection result obtained by the radio wave sensor detecting the object moving on the crosswalk;
generating a movement trajectory of the object in a coordinate space set in advance in the radio wave sensor, based on the detection result; and
determining a detection area corresponding to the crosswalk in the coordinate space, based on the movement trajectory of the object, wherein
the detection area includes a first area including the crosswalk, and
the determining includes determining a boundary line between the first area and a second area in which a passerby waits to cross the crosswalk, based on a movement trajectory of a vehicle traveling on a first roadway, the first roadway having a portion overlapping the crosswalk.

15. The non-transitory computer-readable storage medium storing a computer program according to claim 14, wherein
the detection area further includes the second area.

16. The setting device for a radio wave sensor according to claim 2, wherein
the determination circuitry is configured to determine the boundary line, based on a movement trajectory of a vehicle turning right or left at an intersection between the first roadway and a second roadway intersecting the first roadway.

17. The setting device for a radio wave sensor according to claim 4, wherein
the detection area includes, as the second area, a first waiting area and a second waiting area, the first waiting area being in contact with an incoming lane where a vehicle is to enter the intersection on the first roadway, the second waiting area being in contact with an outgoing lane where a vehicle exits the intersection on the first roadway, and
the determination circuitry is configured to:
determine a first boundary line based on a first movement trajectory, the first boundary line being a boundary line between the first area and the first waiting area, the first movement trajectory being a movement trajectory of a vehicle turning left or right on the incoming lane and entering the second roadway; and
determine a second boundary line based on a second movement trajectory, the second boundary line being a boundary line between the first area and the second waiting area, the second movement trajectory being a movement trajectory of a vehicle turning left or right on the second roadway and entering the outgoing lane.

18. The setting device for a radio wave sensor according to claim 2, wherein
the determination circuitry is configured to determine the boundary line, based further on a detection position of a passerby waiting to cross the crosswalk, the detection position being detected by the radio wave sensor.

19. The setting device for a radio wave sensor according to claim 3, wherein
the determination circuitry is configured to determine the boundary line, based further on a detection position of a passerby waiting to cross the crosswalk, the detection position being detected by the radio wave sensor.

20. The setting device for a radio wave sensor according to claim 4, wherein
the determination circuitry is configured to determine the boundary line, based further on a detection position of a passerby waiting to cross the crosswalk, the detection position being detected by the radio wave sensor.
